(19) United States
(12) Patent Application Publication
(10) Pub. No.: US 2024/0235902 A1
(43) Pub. Date: Jul. 11, 2024

(54) Adaptive Decision Feedback Equalization Tuning

(71) Applicant: Altera Corporation, San Jose, CA (US)

(72) Inventor: Mitchell Cooke, Toronto (CA)

(21) Appl. No.: 18/617,467

(22) Filed: Mar. 26, 2024

(51) Int. Cl. H04L 25/03

(52) U.S. Cl. CPC H04L 25/03057; H04L 25/03267

(57) ABSTRACT

A device of the present disclosure may include interface circuitry and a decision feedback equalization (DFE) tuner. The interface circuitry may be coupled to DFE circuitry by data interconnect. The DFE tuner may control adaptation of the DFE circuitry to a channel associated with the data interconnect using an oscillating reference voltage provided to the DFE circuitry. The interface circuitry may be coupled between the DFE tuner and the DFE circuitry.

### BACKGROUND

The present disclosure relates generally to signal processing, and more specifically to adaptive decision feedback equalization (DFE) tuning.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

Data may be transferred from a transmitter to a receiver using a non-ideal (e.g., lossy and/or reflective) channel. Physical characteristics of the channel may reduce or degrade signal fidelity via inter-symbol interference (ISI), crosstalk, and other forms of signal fidelity loss. Increasing a rate of data transferred from the transmitter to the receiver may increase signal fidelity loss on the channel. Decision feedback equalization (DFE) may be implemented to reduce signal fidelity loss on the channel.

### BRIEF DESCRIPTION OF THE DRAWINGS

Various aspects of this disclosure may be better understood upon reading the following detailed description and upon reference to the drawings in which:

FIG. 1 is a block diagram of a system including a first device with a decision feedback equalization (DFE) tuner and a second device with DFE circuitry, in accordance with aspects of the present disclosure;

FIG. 2 is a diagram that illustrates an example of signal flow for a link with DFE, in accordance with aspects of the present disclosure;

FIG. 3 is a block diagram of a system including the first device and the second device where the first device is a host processor and the second device is a memory module, in accordance with aspects of the present disclosure;

FIG. 4 is a schematic diagram of an example implementation of the DFE circuitry, in accordance with aspects of the present disclosure;

FIG. 5 is a diagram of example bit error rate (BER) as a function of DFE tap weight values, in accordance with aspects of the present disclosure;

FIG. 6 is a diagram of an example data eye for a channel without DFE, in accordance with aspects of the present disclosure;

FIG. 7 is a diagram of an example data eye for a channel with DFE, in accordance with aspects of the present disclosure;

FIG. 8 is example pseudocode for implementing adaptive DFE tuning, in accordance with aspects of the present disclosure;

FIG. 9 is a diagram of example convergence plots, in accordance with aspects of the present disclosure;

FIG. 10 is a diagram of example shmoo plots, in accordance with aspects of the present disclosure; and

FIG. 11 is a block diagram of an example data processing system that may incorporate the system of FIG. 1, in accordance with aspects of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As described above, decision feedback equalization (DFE) may be implemented to reduce signal fidelity loss on a non-ideal (e.g., lossy) channels or physical transmission media that communicatively couple devices for exchanging data signals. For example, DFE may be implemented at a receiving device to reduce or suppress signal fidelity loss such as inter-symbol interference (ISI) by increasing high frequency content of data signals without amplifying noise content such as crosstalk. DFE generally involves filtering a data signal with a number of taps that each store delayed samples of data encoded in the data signal. Each tap may have a tap weight with a value that controls a weight or relative contribution of a corresponding delayed sample of data to a current sample of the data. DFE tuning may be implemented using an optimization process such as stochastic gradient descent that tunes or adjusts each tap weight value to improve signal integrity.

Different approaches for implementing DFE tuning may measure error using different signals to obtain a desired trade-off between stability and robustness. For example, some approaches for implementing DFE tuning may measure error using analog signals received from a channel and equalized or filtered signals that correspond to the received analog signals following DFE correction. Such approaches may use the received analog signals and the equalized or filtered signals to determine analog error vectors for implementing DFE tuning. While effective, analog signals received from a channel and equalized or filtered signals that correspond to the received analog signals following DFE correction may be unavailable for measuring error in some architectures that implement DFE. For example, some architectures that implement DFE such as double data rate fifth generation (DDR5) architectures may have architectural restrictions that limit available signals for measuring error to transmitted signals that include data coded for transmission via a channel and quantized signals that DFE circuitry output based on the transmitted signals.

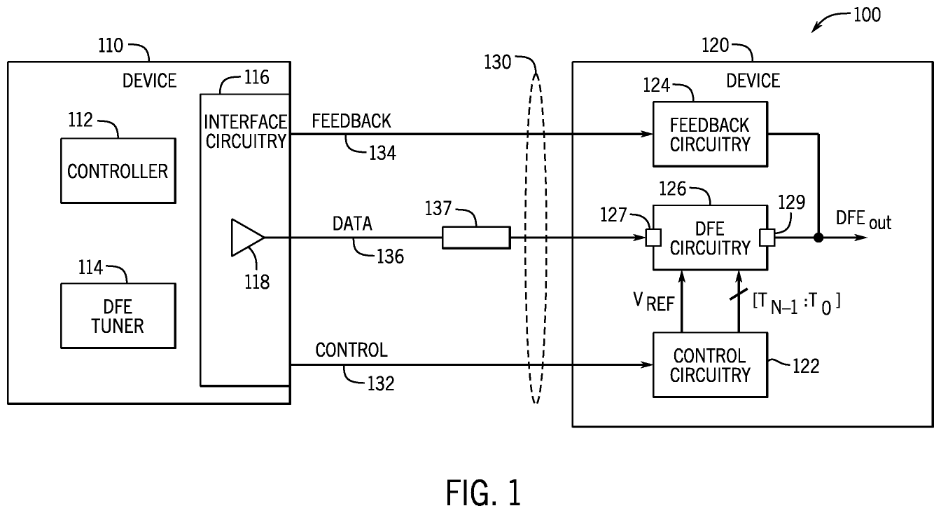

With the foregoing in mind, FIG. 1 is a block diagram of a system 100 that may include a first device 110 with a controller 112, a decision feedback equalization (DFE) tuner 114, and interface circuitry 116 that may include a driver 118. The system 100 may also include a second device 120 with control circuitry 122, feedback circuitry 124, and DFE circuitry 126 that may include an input 127 and an output 129. The interface circuitry 116 of the first device 110 may be coupled to the second device 120 by interconnect 130. In an embodiment, the interconnect 130 may include wired transmission media, such as connectors, lines, traces, pins, pads, buses, and other wired transmission media. In an embodiment, the interconnect 130 may include wireless transmission media, such as radio frequency (RF), infrared, microwave, and other wireless transmission media. The interconnect 130 may include control interconnect 132, feedback interconnect 134, and data interconnect 136 that includes a channel 137. In an embodiment, the control interconnect 132 may be coupled between the interface circuitry 116 of the first device 110 and the control circuitry 122 of the second device 120. In an embodiment, the feedback interconnect 134 may be coupled between the interface circuitry 116 of the first device 110 and the feedback circuitry 124 of the second device 120. In an embodiment, the data interconnect 136 may be coupled between the driver 118 of the first device 110 and the DFE circuitry 126 of the second device 120.

In operation, the controller 112 may cause the driver 118 to transmit data signals to the second device 120 via the channel 137. A data signal may be an analog signal that represents data coded for transmission to the second device 120 as a pattern or stream of data symbols. For example, a data signal may be a non-return-to-zero (NRZ) signal (e.g., a polar NRZ signal) or a Pulse Amplitude Modulation (PAM) signal (e.g., a PAM-4 signal). A unit interval (UI) or time interval may denote a duration of a data symbol in a data signal. A periodicity or frequency of a data timing or strobe signal associated with a data signal may correspond to a UI of a data signal. For example, one UI of a data signal may be equal to a period of the data timing signal. In an embodiment, the controller 112 may cause the interface circuitry 116 to transmit a data timing or strobe signal associated with a data signal to the second device 120.

A data symbol of a data signal transmitted by the driver 118 may represent an integer multiple (e.g., one, two, etc.) of bits of data coded for transmission to the second device 120. For example, a data symbol of a data signal may represent one bit of data coded for transmission to the second device 120 where the data signal is an NRZ signal. As another example, a data symbol of a data signal may represent two bits of data coded for transmission to the second device 120 where the data signal is a PAM-4 signal. A data signal transmitted by the driver 118 may transition between an integer multiple (e.g., two, three, etc.) of voltages. Different voltages of a data signal transmitted by the driver 118 may correspond to different logic or binary values of bits of data coded for transmission to the second device 120. For example, a data signal that is an NRZ signal may transition between a first voltage and a second voltage that correspond to a first logic value (e.g., a binary “1”) and a second logic value (e.g., a binary “0”), respectively. Data signals transmitted by the driver 118 may propagate to the input 127 of the DFE circuitry 126 via the channel 137.

The DFE circuitry 126 may receive data signals at the input 127 from the channel 137. The DFE circuitry 126 may also receive a reference voltage (e.g., VREF) from the control circuitry 122. VREF may be a quantization threshold voltage of a data signal received at the input 127. The quantization threshold voltage may be between a first voltage and a second voltage of the data signal that correspond to a first logic value (e.g., a binary “1”) and a second logic value (e.g., a binary “0”), respectively. The DFE tuner 114 of the first device 110 may control VREF using instructions or signals that the interface circuitry 116 sends to the control circuitry 122 of the second device 120 over the control interconnect 132.

The DFE circuitry 126 may quantize data signals received at the input 127 using VREF to provide quantized signals (DFEₒᵤₜ) at the output 129. DFEₒᵤₜ may include a stream of data symbols that each represent an integer multiple (e.g., one, two, etc.) of bits. A data symbol of DFEₒᵤₜ may be an estimate of a corresponding data symbol in a data signal transmitted by the driver 118. For example, a data signal that includes a data symbol may be received at the input 127 and the DFE circuitry 126 may sample the data signal during a UI of the data symbol. In this example, the DFE circuitry 126 may compare the sample of the data signal to VREF and DFEₒᵤₜ provided at the output 129 may include a data symbol corresponding to the data symbol of the data signal based on that comparison.

The feedback circuitry 124 may provide a feedback signal based on DFEₒᵤₜ provided at the output 129 of the DFE circuitry 126. The feedback circuitry 124 may provide the feedback signal to the interface circuitry 116 of the first device 110 over the feedback interconnect 134. In an embodiment, the feedback circuitry 124 may also provide a feedback timing signal that corresponds to the feedback signal. In an embodiment, the feedback circuitry 124 may provide the feedback timing signal based on a data timing signal sent by the interface circuitry 116 of the first device 110.

Differences may exist between data symbols of DFEₒᵤₜ provided at the output 129 and corresponding data symbols of data signals transmitted by the driver 118. Such differences may relate to signal fidelity loss introduced by the channel 137. Some signal fidelity loss may include ISI related to physical characteristics of the channel 137. ISI generally involves interference between data symbols corresponding to different unit intervals of a data signal. The interference may include a data symbol in a given unit interval of a data signal contributing to data symbols in unit intervals of the data signal that follow the given unit interval. For example, the sample of the data signal during the UI of the data symbol that the DFE circuitry 126 compares to VREF in the preceding example may include contributions from data symbols that correspond to a number of UIs that precede the UI of the data symbol. The sample of the data signal during the UI of the data symbol may be erroneously quantized (e.g., the first logic value being erroneously represented at the output 129 as the second logic value or vice versa) by the DFE circuitry 126 due to the contributions from data symbols of the preceding UIs.

The DFE circuitry 126 may equalize or filter data signals received at the input 127 to reduce signal fidelity loss such as ISI related to physical characteristics of the channel 137. The DFE circuitry 126 may include N-taps that each store a delayed sample of a data signal received at the input 127, where N is an integer number greater than zero. For example, each tap among the N-taps of the DFE circuitry 126 may buffer a data symbol that corresponds to a UI of a data signal that precedes a current UI of the data signal. Each tap among the N-taps of the DFE circuitry 126 may have a programmable tap weight with a value that controls a weight or relative contribution of a corresponding delayed sample of a data signal (e.g., buffered data symbol) to a current sample the data signal. For example, increasing the value of the tap weight may increase the weight or relative contribution of the corresponding delayed sample or buffered data symbol to the current sample. As another example, decreasing the value of the tap weight may decrease the weight or relative contribution of the corresponding delayed sample or buffered data symbol to the current sample.

The DFE tuner 114 of the first device 110 may be generally configured to implement adaptive DFE tuning of the DFE circuitry 126 to reduce signal fidelity loss. The DFE tuner 114 may implement adaptive DFE tuning by causing (e.g., via the controller 112) the driver 118 to transmit data signals with a pattern or stream of training data to the DFE circuitry 126 via the channel 137. The DFE tuner 114 may also implement adaptive DFE tuning by updating or adjusting tap weight values of the DFE circuitry 126 to reduce or minimize error associated with the channel 137 such as a bit error rate (BER) at the output 129 of the DFE circuitry 126. The DFE tuner 114 may cause the control circuitry 122 of the second device 120 to provide the DFE circuitry 126 with updated tap weight values using instructions or signals that the interface circuitry 116 sends to over the control interconnect 132. As described above, different approaches for implementing DFE tuning may measure error using different signals to obtain a desired trade-off between stability and robustness.

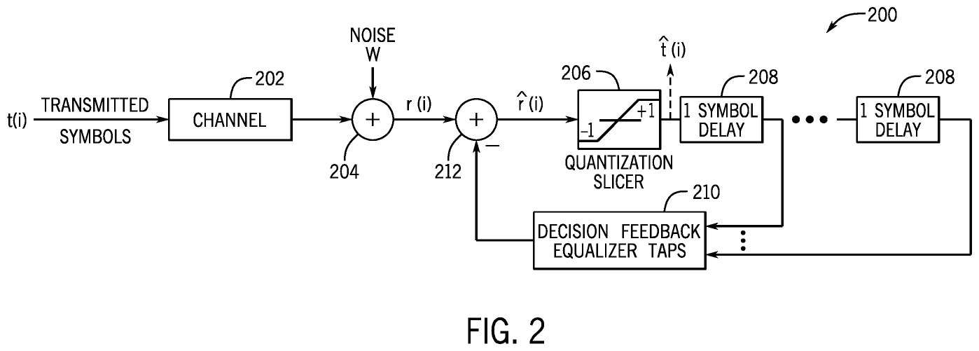

FIG. 2 shows various signals that may be available for measuring error in communication links with DFE. In particular, FIG. 2 is a diagram 200 that illustrates signal flow on a communication link with DFE, in accordance with aspects of the present disclosure. The diagram 200 includes a transmitted signal t(i) that represents data (e.g., training data) coded for transmission via a channel 202 as a pattern or stream of data symbols. Each data symbol may represent an integer number (e.g., one, three, etc.) bits of the data. For example, the transmitted signal t(i) may be a digital signal such as a polar NRZ signal or a PAM signal (e.g., a PAM-4 signal). In an embodiment, the transmitted signal t(i) may be a data signal transmitted by the driver 118 of FIG. 1 to the second device 120 over the channel 137. The diagram 200 also includes a received signal r(i) that represents the transmitted signal t(i) with signal fidelity loss. ISI related to physical characteristics (e.g., finite bandwidth, channel pulse response or impedance discontinuities) of the channel 202 may contribute to the signal fidelity loss. Noise (e.g., additive white Gaussian noise) related to thermal noise, crosstalk, jitter, or other sources of noise may also contribute to the signal fidelity loss. The diagram 200 includes an adder 204 to represent the contribution of noise to the signal fidelity loss. FIG. 2 shows the adder 204 to distinguish the contribution of noise to the signal fidelity loss from the contribution of ISI to the signal fidelity loss. As such, the adder 204 may not be an actual physical component. In an embodiment, the received signal r(i) may be a data signal received at the input 127 of the DFE circuitry 126 from the channel 137 in FIG. 1.

The diagram 200 also includes a filtered or equalized signal \hat{r}(i) that represents the received signal r(i) following DFE correction. The filtered signal \hat{r}(i) may include a difference between the received signal r(i) at a current symbol instance or unit interval DFE correction may involve and a weighted combination of symbol decisions output by a slicer 206 over a number of preceding symbol instances or unit intervals. DFE correction may involve a number of delay elements 208 storing delayed versions of symbol decisions output by the slicer 206. DFE correction may also involve a feedback filter 210 providing an equalization signal to a subtractor 212 based on the delayed versions of symbol decisions stored by the delay elements 208 and a number of DFE tap weights. In an embodiment, the filtered signal \hat{r}(i) may be output by an equalization or filtering operation that is implemented between the input 127 and the output 129 of the DFE circuitry 126. The diagram 200 also includes a quantized signal \hat{t}(i) that represents symbol decisions output by the slicer 206 based on the filtered signal (i). The quantized signal \hat{t}(i) may be an estimate of the pattern or stream of data symbols represented by the transmitted signal t(i). In an embodiment, the quantized signal (i) may be DFEₒᵤₜ provided at the output 129 of the DFE circuitry 126 in FIG. 1.

Absent architectural restrictions, error may be measured for implementing DFE tuning using various combinations of the transmitted signal t(i), the received signal r(i), the filtered signal \hat{r}(i), and the quantized signal \hat{r}(i) shown in FIG. 2. For example, some approaches may use the received signal r(i) and the filtered signal \hat{r}(i) to determine analog error vectors for implementing DFE tuning, as described above. Such approaches may be ineffective for implementing DFE tuning in architectures where the received signal r(i) and the filtered signal \hat{r}(i) may be unavailable due to architectural restrictions.

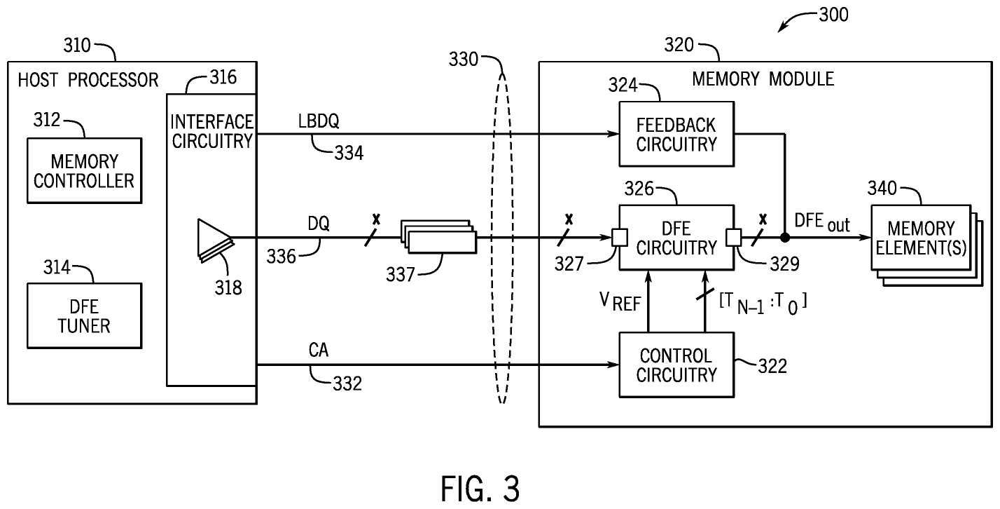

FIG. 3 shows an example of an architecture for implementing DFE tuning where the received signal r(i) and the filtered signal \hat{r}(i) may be unavailable due to architectural restrictions. FIG. 3 is a block diagram of a system 300 that may be compatible with a double data rate (DDR) memory technology or standard developed by the Joint Electron Device Engineering Council (JEDEC) such as a DDR version 5 (DDR5) memory technology or standard. The system 300 may be a specific embodiment of the system 100. However, other embodiments may also be consistent with aspects of the present disclosure.

The system 300 may include a host processor 310 and elements of a memory subsystem such as a memory module 320. The host processor 310 may include a memory controller 312, a DFE tuner 314, and interface circuitry 316 that may include one or more drivers 318. The host processor 310, the memory controller 312, the DFE tuner 314, the interface circuitry 316, and the one or more drivers 318 may be an embodiment of the first device 110, the controller 112, the DFE tuner 114, the interface circuitry 116, and the driver 118 of FIG. 1, respectively.

The memory module 320 with control circuitry 322, feedback circuitry 324, one or more DFE circuits 326. Each DFE circuit 326 may include a respective input 327 and a respective output 329. The memory module 320, the control circuitry 322, the feedback circuitry 324, and the one or more DFE circuits 326 may be an embodiment of the second device 120, the control circuitry 122, the feedback circuitry 124, and the DFE circuitry 126 of FIG. 1, respectively. The respective input 327 and the respective output 329 of each DFE circuit 326 may be an embodiment of the input 127 and the output 129 of the DFE circuitry 126 of FIG. 1, respectively. The memory module 320 may also include one or more memory elements 340 that may provide volatile or non-volatile memory that may be accessible by the memory controller 312 of the host processor 310. In an embodiment, the memory module 320 may be implemented using a dual in-line memory module (DIMM). In an embodiment, the one or more memory elements 340 may be implemented using dynamic random-access memory (DRAM) devices. In an embodiment, the control circuitry 322 may be implemented as a registered clock driver (RCD) to interpret control signals sent by the interface circuitry 316.

The interface circuitry 316 of the host processor 310 may be coupled to the memory module 320 by interconnect 330. In an embodiment, the host processor 310 may communicate with the memory module 320 over the interconnect 330 in accordance with a DDR memory technology or standard developed by the JEDEC such as a DDR5 memory technology or standard. The interconnect 330 may include control interconnect 332 (e.g., command and address interconnect) and feedback interconnect 334. In an embodiment, the control interconnect 332 may be coupled between the interface circuitry 316 of the host processor 310 and the control circuitry 322 of the memory module 320. In an embodiment, the control circuitry 322 may be implemented using a registered clock driver. In an embodiment, the feedback interconnect 334 may be coupled between the interface circuitry 316 of the host processor 310 and the feedback circuitry 324 of the memory module 320.

The interconnect 330 may also include x-data interconnects 336, where x is an integer number greater than zero. Each data interconnect of the x-data interconnects 336 may include a different respective channel 337. In an embodiment, the x-data interconnects 336 may be coupled between the one or more drivers 318 of the host processor 310 and the one or more DFE circuits 326 of the memory module 320. In an embodiment, a ratio between the x-data interconnects 336 and the one or more DFE circuits 326 may be equal to one. For example, the one or more DFE circuits 326 of the memory module 320 may include x-DFE circuits (e.g., one DFE circuit for each data interconnect). In an embodiment, a ratio between the x-data interconnects 336 and the one or more DFE circuits 326 may be different than one. For example, the one or more DFE circuits 326 of the memory module 320 may include x+1 or x−1 DFE circuits.

In operation, the memory controller 312 may cause the one or more drivers 318 to transmit data signals (e.g., DQ) to the memory module 320 via a respective channel 337. For example, the memory controller 312 may cause the one or more drivers 318 to transmit data signals during a write operation. Data signals transmitted by the one or more drivers 318 may correspond to the transmitted signal t(i) of FIG. 2. The one or more DFE circuits 326 may receive data signals at a respective input 327 from a respective channel 337. Data signals received by the one or more DFE circuits 326 may correspond to the received signal r(i) of FIG. 2. The one or more DFE circuits 326 may also receive VREF from the control circuitry 322.

The one or more DFE circuits 326 may quantize data signals received at a respective input 327 using VREF to provide DFEₒᵤₜ at a respective output 329. DFEₒᵤₜ that the one or more DFE circuits 326 provided at a respective output 329 may correspond to the quantized signal \hat{t}(i) of FIG. 2. The feedback circuitry 324 may provide a feedback signal (e.g., LBDQ) based on DFEₒᵤₜ provided at a respective output 329 of the one or more DFE circuits 326. The feedback circuitry 324 may provide a feedback signal to the interface circuitry 316 of the host processor 310 over the feedback interconnect 334. In an embodiment, the feedback circuitry 324 may also provide a feedback timing signal (e.g., LBDQS) that corresponds to the feedback signal. The one or more DFE circuits 326 may equalize or filter data signals received at a respective input 327 to reduce signal fidelity loss such as ISI by implementing an equalization or filtering operation between a respective input 327 and a respective output 329. Outputs of a respective equalization or filtering operation (e.g., data signals received by the one or more DFE circuits 326 following DFE correction) may correspond to the filtered signal \hat{r}(i) of FIG. 2.

The DFE tuner 314 of the host processor 310 may be generally configured to implement adaptive DFE tuning of the one or more DFE circuits 326 to reduce signal fidelity loss. The DFE tuner 314 may implement adaptive DFE tuning by causing (e.g., via the memory controller 312) the one or more drivers 318 to transmit data signals with a pattern or stream of training data to the one or more DFE circuits 326 via a respective channel 337. The DFE tuner 314 may also implement adaptive DFE tuning by updating or adjusting tap weight values of the one or more DFE circuits 326 to reduce or minimize error associated with a respective channel 337. The DFE tuner 314 may cause the control circuitry 322 of the memory module 320 to provide the one or more DFE circuits 326 with updated tap weight values using instructions or signals that the interface circuitry 316 sends to over the control interconnect 332.

Data signals received by the one or more DFE circuits 326 and the data signals following DFE correction (e.g., the received signal r(i) and the filtered signal \hat{r}(i) of FIG. 2, respectively) may be unavailable to the DFE tuner 314 for measuring error due to architectural restrictions of the DDR memory technology or standard such as the DDR5 memory technology or standard. Data signals transmitted by the one or more drivers 318 (e.g., the transmitted signal t(i) of FIG. 2) may be available to the DFE tuner 314 for measuring error in accordance with the DDR memory technology or standard developed by JEDEC such as the DDR5 memory technology or standard. DFEₒᵤₜ provided at a respective output 329 of the one or more DFE circuits 326 (e.g., the quantized signal \hat{r}(i) of FIG. 2) may also be available to the DFE tuner 314 for measuring error via feedback signals provided by the feedback circuitry 324. Accordingly, the DFE tuner 314 of the host processor 310 may measure error using data signals transmitted by the one or more drivers 318 and DFEₒᵤₜ provided at a respective output 329 of the one or more DFE circuits 326 for implement adaptive DFE tuning.

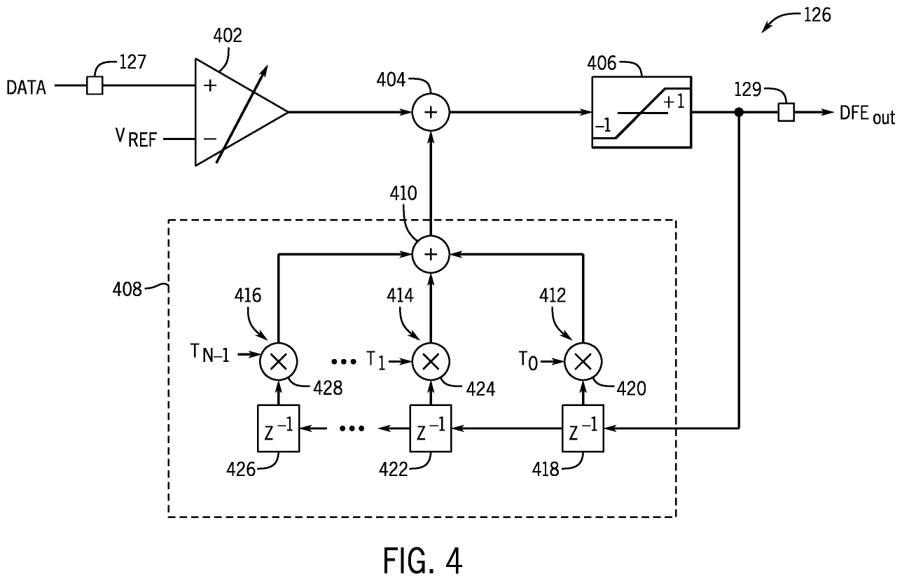

FIG. 4 is a block diagram of an example implementation of the DFE circuitry 126 that may be configured to provide DFEₒᵤₜ at the output 129 based on data signals provided at the input 127. In FIG. 4 the example implementation of the DFE circuitry 126 includes an amplifier 402, a first adder 404, a slicer 406 (e.g., a sampler and/or a decision circuit), and a feedback filter 408. The feedback filter 408 may include a second adder 410. The feedback filter 408 may also include N-taps (e.g., 4-taps) formed by N-delay elements and N-multipliers. The N-taps of the feedback filter 408 may include a first tap 412, a second tap 414, and a third tap 416. The N-delay elements may include a first delay element 418, a second delay element 422, and a third delay element 426. The N-multipliers may include a first multiplier 420, a second multiplier 424, and a third multiplier 428. In an embodiment, the amplifier 402 may have an adjustable or programmable gain.

In an example architecture of the DFE circuitry 126, a first input (e.g., a non-inverting input), a second input (e.g., an inverting input), and an output of the amplifier 402 may be coupled to the input 127, a source of VREF (e.g., control circuitry 122), and a first input of the first adder 404, respectively. A second input and an output of the first adder 404 may be coupled to an output of the second adder 410 and an input of the slicer 406, respectively. An output of the slicer 406 may be coupled to the output 129 and an input of the first delay element 418. First and second outputs of the first delay element 418 may be coupled to a first input of the first multiplier 420 and an input of the second delay element 422, respectively. A second input and an output of the first multiplier 420 may be coupled to a source (e.g., control circuitry 122) of a first tap weight (To) and a first input of the second adder 410, respectively. First and second outputs of the second delay element 422 may be coupled to a first input of the second multiplier 424 and an input of the third delay element 426, respectively. A second input and an output of the second multiplier 424 may be coupled to a source (e.g., control circuitry 122) of a second tap weight (T₁) and a second input of the second adder 410, respectively. A first input, a second input, and an output of the third multiplier 428 may be coupled to an output of the third delay element 426, a source (e.g., control circuitry 122) of a third tap weight (T_{N-1}), and a third input of the second adder 410, respectively. An output of the second adder 410 may be coupled to a second input of the first adder 404.

In an example operation of the DFE circuitry 126, the first input of the amplifier 402 may receive a data signal (e.g., DQ) at the input 127 during a current unit interval. In an embodiment, the data signal received at the input 127 may correspond to the received signal r(i) of FIG. 2. The second input of the amplifier 402 may also receive VREF during the current unit interval. The output of the amplifier 402 may provide a sample signal based on the data signal and VREF during the current unit interval. In an embodiment, an edge (e.g., a rising edge and/or a falling edge) of a data timing or strobe signal (e.g., a DQS signal) associated with the data signal may trigger the amplifier 402 to sample data signals provided at the input 127. For example, the amplifier 402 may sample a data signal provided at the input 127 during each unit interval associated with the data signal. The output of the first adder 404 may provide a corrected sample signal based on the sample signal provided at the output of the amplifier 402 during the current unit interval and an equalization or correction signal provided by the feedback filter 408. The corrected sample signal provided at the output of the first adder 404 may be referred to as a received data signal following DFE correction. In an embodiment, the corrected sample signal provided at the output of the first adder 404 may correspond to the filtered signal \hat{r}(i) of FIG. 2.

The equalization signal provided by the feedback filter 408 may be based N-data symbols of DFEₒᵤₜ provided at the output of the slicer 406 before the current unit interval of the data signal. The N-data symbols of DFEₒᵤₜ provided at the output of the slicer 406 may correspond to N-unit intervals of the data signal that precede the current unit interval. The N-data symbols of DFEₒᵤₜ provided at the output of the slicer 406 before the current unit interval of the data signal may contribute to the equalization signal by operation of the N-delay elements (e.g., delay elements 418, 422, and 426) and the second adder 410. A value of a tap weight provided to a respective multiplier of each tap of the feedback filter 408 may control a weight or relative contribution of a corresponding data symbol of DFEₒᵤₜ among the N-data symbols to the equalization signal provided by the feedback filter 408. For example, increasing the value of the tap weight may increase the weight or relative contribution of the corresponding data symbol of DFEₒᵤₜ to the equalization signal provided by the feedback filter 408. As another example, decreasing the value of the tap weight may decrease the weight or relative contribution of the corresponding data symbol of DFEₒᵤₜ to the equalization signal provided by the feedback filter 408.

The output of the slicer 406 may provide a data symbol of DFEₒᵤₜ for the current unit interval of the data signal based on the corrected sample signal provided at the output of the first adder 404 for the current unit interval. For example, the slicer 406 may be configured to provide the data symbol of DFEₒᵤₜ for the current unit interval of the data signal by quantizing the corrected sample signal provided at the output of the first adder 404 for the current unit interval. The data symbol of DFEₒᵤₜ at the output of the slicer 406 for the current unit interval of the data signal may be provided to the input of the first delay element 418. The data symbol of DFEₒᵤₜ provided at the output of the slicer 406 for the current unit interval of the data signal may also be provided at the output 129 of the DFE circuitry 126 for further processing (e.g., downstream processing).

As described above with reference to FIG. 1, the DFE tuner 114 of the first device 110 may be generally configured to implement adaptive DFE tuning to set or adjust tap weight of the DFE circuitry 126. Implementing adaptive DFE tuning may involve the DFE tuner 114 causing (e.g., via the controller 112) the driver 118 to transmit data signals with training data to the DFE circuitry 126 via the channel 137. The training data of the data signals may be coded for transmission via the channel 137 as a pattern or stream of data symbols. The data signals with the training data may be received at the input 127 and quantized by the DFE circuitry 126 to provide DFE_{OUT} at the output 129. The DFE tuner 114 may receive (e.g., via the controller 112) feedback signals from the feedback circuitry 124 via the feedback interconnect 134. The feedback circuitry 124 may provide the feedback signals based on DFE_{OUT} that the DFE circuitry 126 provides at the output 129 responsive to quantizing the data signals with the training data. The DFE tuner 114 may measure error associated with the channel 137 using the data signals with the training data transmitted by the driver 118. The DFE tuner 114 may also measure error associated with the channel 137 using the feedback signals that the feedback circuitry 124 provides based on DFE_{OUT} at the output 129 of the DFE circuitry 126.

The DFE tuner 114 may determine updated tap weight values of the DFE circuitry 126 to reduce or minimize the measured error associated with the channel 137. For example, the DFE tuner 114 may provide the data signals with the training data and/or the feedback signals that the feedback circuitry 124 provides based on DFE_{OUT} at the output 129 of the DFE circuitry 126 as input to an optimization process such as stochastic gradient descent optimization process. The optimization process may update or adjust each tap weight value to improve signal integrity or reduce error as measured by one or more of the data signals with the training data transmitted by the driver 118 and/or the feedback signals provided by the feedback circuitry 124. In an embodiment, the optimization process of the DFE tuner 114 may be implemented using one or more of software (e.g., firmware) executing on the first device 110 and hardware (e.g., register-transfer level logic implemented in a programmable fabric and/or hardware circuitry) of the first device 110.

In an embodiment, a DFE tuner (e.g., the DFE tuner 114) may determine updated values for one or more tap weights of DFE circuitry (e.g., the DFE circuitry 126) according to:

p_{K}(i+1)=pₖ(i)+μ(i)Aₖ(i) (1)

where k denotes a tap weight index, i denotes a symbol instance or index in a stream or pattern of data symbols of training data, pₖ(i) denotes a value of a tap weight for tap k of N-taps at symbol instance i to form a tap weight vector (\vec{p}), u(i) denotes an adaptive tap step size at symbol instance i, and Aₖ(i) denotes a value of a tap error accumulator at symbol instance i. In an embodiment, \vec{p}∈ [symbol] ^{N} and/or μ(i)∈ [symbol] . In an embodiment, an adaptive tap step size

A value of an offset or delta voltage parameter (V_{Δ}) may control a value of μ(i). An inverse relationship may exist between the value of V_{Δ} and the value of μ(i). For example, increasing the value of V_{Δ} may decrease the value of μ(i). As another example, decreasing the value of V_{Δ} may increase the value of μ(i). The value of V_{Δ} may control the value of μ(i) to decrease proportional to an effective BER at an output of the DFE circuitry. In an embodiment, μ(i) may be determined according to:

$$μ ( i ) = ⌊ \frac{{μ}_{0} - 1}{1 + α {V}_{Δ} ( i )} ⌋ + 1 \qquad ( 2 )$$

where μ₀ denotes an initial (or starting) tap step size in terms of a quantization tap step size of the DFE circuitry, and a denotes a decay rate parameter for μ(i). In an embodiment, a value of μ₀ may control a convergence rate associated with adaptation of the DFE circuitry to the channel. A value of a may control a rate at which the value of V_{Δ} may control the value of μ(i) to decrease. In an embodiment where μ(i) is determined according to equation (2), a flow operator and a vertical shift of 1 step may ensure that a value of μ(i) approaches 1 (e.g., a single quantization step) as the value of V_{Δ} becomes sufficiently large based on the value of a.

In an embodiment, Aₖ(i) may be determined according to:

$${A}_{k} ( i ) = \{ \begin{matrix}0 & if i mod b \neq 0 \\ + 1 & if {\sum }_{j = 1}^{b - 1} sgn ( \hat{r} ( i - k - j ) ) sgn ( e ( i - j ) ) > + q \\ - 1 & if {\sum }_{j = 1}^{b - 1} sgn ( \hat{r} ( i - k - j ) ) sgn ( e ( i - j ) ) < - q\end{matrix} \qquad ( 3 )$$

where e(i) represents an error or difference at symbol instance i between a transmitted signal provided to a channel and a quantized signal provided at the output of the DFE circuitry (e.g., e(i)=t(i)−\hat{t}(i)), b denotes a block size of the tap error accumulator, and q denotes a bit-error threshold for the block size of b. In an embodiment, and with reference to FIG. 2, sgn(\hat{r}(i−k−j)) may be determined according to:

sgn(\hat{r}(i−k−j))=sgn(\hat{t}(i−k−j)) (4)

In an embodiment where sgn(\hat{r}(i−k−j)) is determined according to equation (4), Aₖ(i) may be determined according to equation (3) based on bits or data symbols of a transmitted data signal (e.g., t(i)) provided to a channel and corresponding bits or data symbols of a quantized signal (e.g., \hat{t}(i)) provided at the output of DFE circuitry.

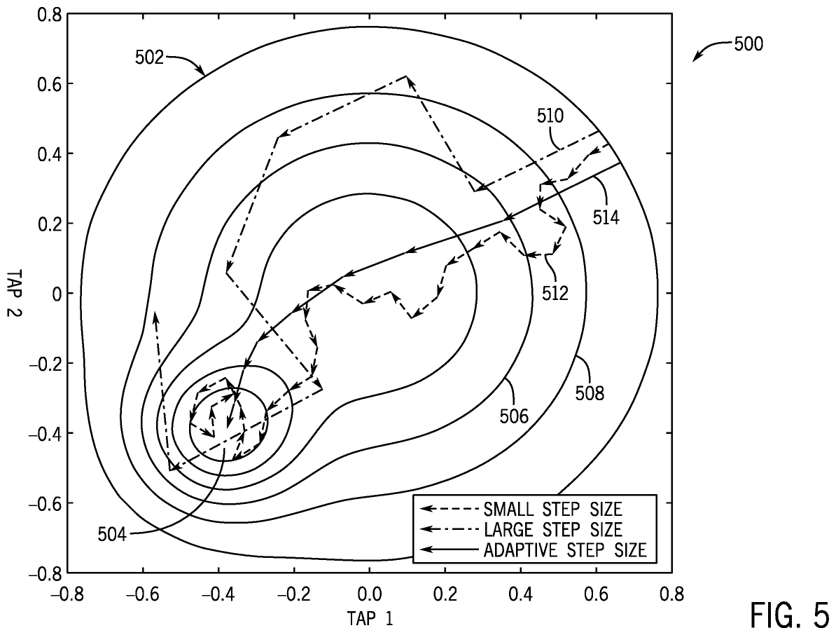

One or more tap error accumulators (e.g., Aₖ(i)) of the DFE tuner may have respective values or magnitudes that indirectly or implicitly measure a channel BER surface. For example, respective values or magnitudes of the one or more tap error accumulators may indirectly or implicitly measure channel BER surfaces similar to the example shown by FIG. 5. In an embodiment, uncorrelated errors (e.g., bit, symbol, or quantization errors at an output of the DFE circuitry that are not correlated with a pattern or stream of training symbols) may determine a value or magnitude of at least one tap error accumulator more than correlated errors (e.g., bit, symbol, or quantization errors at an output of the DFE circuitry that are correlated with a pattern or stream of training symbols). For example, uncorrelated errors may determine a value or magnitude of a given tap error accumulator more than correlated errors when tap weights fail to update for a large number of taps (e.g., N-taps) that compose the DFE circuitry. The DFE tuner may increase V_{Δ}(i) over time to force adaptation of tap weights to lower an effective BER at the output of the DFE circuitry. By increasing V_{Δ}(i), the DFE tuner may increase curvature of the channel BER surface. The DFE tuner may continue to increase V_{Δ}(i) monotonically during adaptation (e.g., absent tap weight updates) until the DFE tuner detects correlated errors at the output of the DFE circuitry. The DFE tuner may detect correlated errors at the output of the DFE circuitry when a value or magnitude of one or more tap error accumulators exceeds q. In an embodiment, V_{Δ}(i) may be determined according to:

$$V Δ ( i ) = \{ \begin{matrix}0 & if i = 0 \\ {V}_{Δ} ( i - 1 ) + 1 & if {A}_{k} ( i ) < q ; ∀ k\end{matrix} \qquad ( 5 )$$

FIG. 5 is a plot 500 that illustrates example convergence behavior in a BER versus tap weight space for different tap step sizes (e.g., μ(i)). The plot 500 includes a surface 502 that represents BER of an equalized channel with changing DFE tap weights. Within the surface 502, values of BER generally decrease towards a region 504 (e.g., a minimal region) of the surface 502 that corresponds to lower values of BER. For example, values of BER corresponding to a region 506 of the surface 502 may be less than values of BER corresponding to a region 508 of the surface 502. The plot 500 also includes lines 510, 512, and 514 that represent DFE tuning using a first step size (e.g., a large step size), a second step size (e.g., a small step size), and an adaptive step size, respectively.

In FIG. 5, each line includes multiple vectors that each represent a different tap weight update. A magnitude of each vector may represent a step size of a corresponding tap weight update. For example, the lines 510 and 512 representing DFE tuning using the first and second step sizes, respectively, each comprise vectors with static or constant magnitudes. In this example, the static or constant magnitude of each vector composing the line 510 that represents DFE tuning using the first step size may be larger than the static or constant magnitude of each vector composing the line 512 that represents DFE tuning using the second step size. As another example, the line 514 that represents DFE tuning using the adaptive step size comprises vectors with different magnitudes. In this example, magnitudes of the vectors composing the line 514 that represents DFE tuning using the adaptive step size may decrease as the line 514 approaches the region 504 that corresponds to lower values of BER.

The plot 500 shows that DFE tuning using the first step size (e.g., a large step size), as represented by the line 510, may be unable to convergence and its stability may be subject to noise (e.g., Gaussian gradient noise). The plot 500 also shows that DFE tuning using the second step size (e.g., a small step size), as represented by the line 512, may experience longer convergence times related to wandering from gradient noise. The plot 500 further shows that the DFE tuning using the adaptive step size that decreases over time, as represented by the line 514, may provide convergence that is both accurate and balanced with step directions being unimpacted by gradient noise.

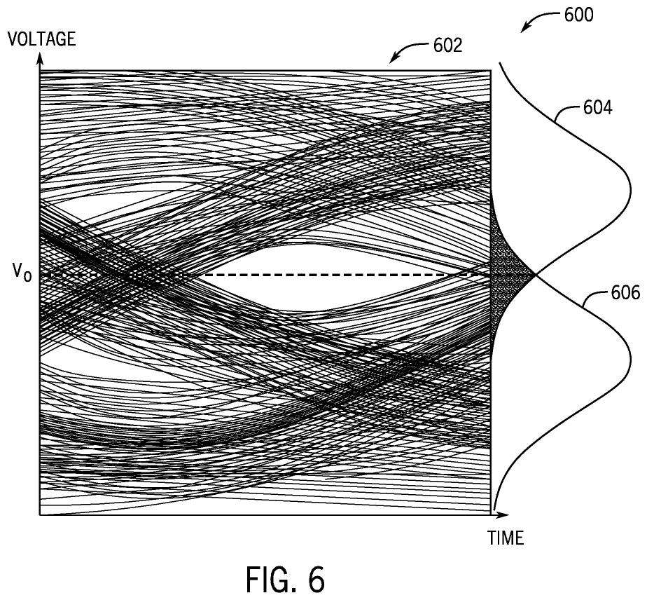

FIG. 6 is a diagram 600 of an example data eye 602 for a channel without DFE (e.g., an unequalized channel). The data eye 602 may represent voltage of a data signal at receiver-side of the channel (e.g., between the channel 137 and the second device 120 of FIG. 1), as a function of time. In FIG. 6, the data signal may be an NRZ signal (e.g., a polar NRZ signal) and Vₒ may represent a quantization threshold voltage or an ideal reference voltage of the NRZ signal. The diagram 600 includes a first sample distribution 604 and a second sample distribution 606 that correspond to a first logic value (e.g., a binary “1”) and to a second logic value (e.g., a binary “0”) of the NRZ signal, respectively. Vₒ may be at a midpoint between positive and negative pulse heights of the NRZ signal. A static reference voltage of Vₒ may be provided to quantize samples of the NRZ signal. Darkened areas of the first sample distribution 604 and the second sample distribution 606 below and above Vₒ may represent quantization errors (e.g., bit or symbol errors) using the static reference voltage. For example, the darkened area of the first sample distribution 604 may include samples of the NRZ signal corresponding to the first logic value that are erroneously represented at a quantization output as the second logic value. As another example, the darkened area of the second sample distribution 606 may include samples of the NRZ signal corresponding to the second logic value that are erroneously represented at the quantization output as the first logic value.

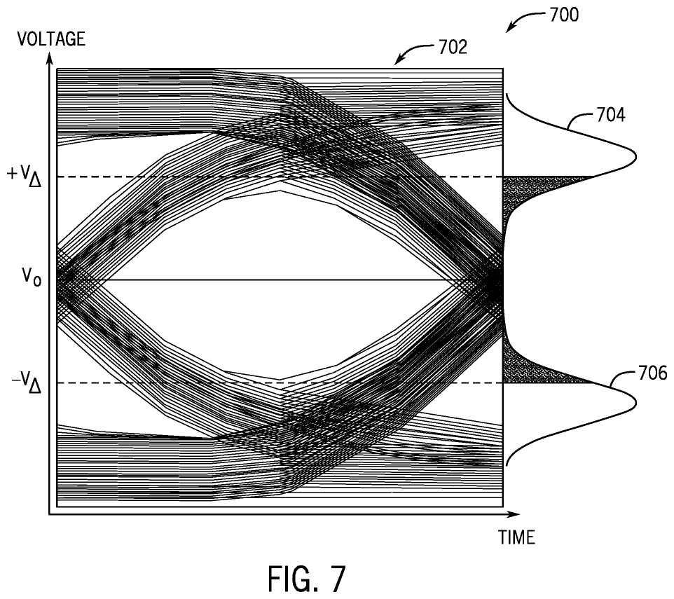

FIG. 7 is a diagram 700 of an example data eye 702 for a channel with adaptive DFE, in accordance with aspects of the present disclosure. The data eye 702 may represent voltage of a data signal at the input 127 of the DFE circuitry 126 of FIG. 1, as a function of time. In FIG. 7, the data signal may be an NRZ signal (e.g., a polar NRZ signal) and Vₒ may represent a quantization threshold voltage of the NRZ signal. The diagram 700 includes a first sample distribution 704 and a second sample distribution 706 that correspond to a first logic value (e.g., a binary “1”) and to a second logic value (e.g., a binary “0”) of the NRZ signal, respectively. Vₒ may be at a midpoint between positive and negative pulse heights of the NRZ signal. An oscillating reference voltage may be provided to quantize samples of the NRZ signal. The oscillating reference voltage may be centered at Vₒ. The oscillating reference voltage may cycle or transition between a first voltage (e.g., Vₒ+V_{Δ}) and a second voltage (e.g., Vₒ−V_{Δ}). A difference between the first and second voltages may represent an amplitude of the oscillating reference voltage. For example, the control circuitry 122 may provide an oscillating reference voltage of Vₒ±V_{Δ} to the DFE circuitry 126. Darkened areas of the first sample distribution 704 and the second sample distribution 706 below the first voltage (e.g., Vₒ+V_{Δ}) and above the second voltage (e.g., Vₒ−V_{Δ}), respectively, may represent quantization errors using the oscillating reference voltage. For example, the darkened area of the first sample distribution 704 may include samples of the NRZ signal corresponding to the first logic value that are erroneously represented at a quantization output (e.g., the output 129 of the DFE circuitry 126 of FIG. 1) as the second logic value. As another example, the darkened area of the second sample distribution 706 may include samples of the NRZ signal corresponding to the second logic value that are erroneously represented at the quantization output as the first logic value. The darkened area of the first sample distribution 704 may be equal or substantially similar to the darkened area of the second sample distribution 706. In an embodiment, the quantization errors represented by the darkened area of the first sample distribution 704 may generally correspond to bit errors or symbol errors caused by setting the first voltage (e.g., Vₒ+V_{Δ}) close or proximate to a mean of the first sample distribution 704. In an embodiment, the quantization errors represented by the darkened area of the second sample distribution 706 may generally correspond to bit errors or symbol errors caused by setting the first voltage (e.g., Vₒ-V_{Δ}) close or proximate to a mean of the second sample distribution 706.

A comparison between FIGS. 6 and 7 shows that oscillating or changing a reference voltage provided for quantizing samples of a data signal may allow a controllable change in quantization error (e.g., controllable changes in bit errors or symbol errors). Controllable changes in quantization error, such as bit errors or symbol errors, can include reducing an absolute error for samples of a data signal to be erroneously quantized (e.g., the first logic value being erroneously represented at a quantization output as the second logic value or vice versa). For example, the darkened area of the first sample distribution 704 may be less than the darkened area of the first sample distribution 604. As another example, the darkened area of the second sample distribution 706 may be less than the darkened area of the second sample distribution 606. Controllable changes in quantization error can also include lower variance in quantization error sample distributions. For example, a variance of the first sample distribution 704 may be lower than a variance of the first sample distribution 604. As another example, a variance of the second sample distribution 706 may be less than a variance of the second sample distribution 606. A comparison between the data eye 702 and the data eye 602 shows that lower variance in quantization error sample distributions may involve variation of a data signal at a receiver-side of an equalized channel being less than variation of a data signal at a receiver-side of an unequalized channel.

Convergence rates may decrease, as channel performance improves (e.g., as a data eye opens), inasmuch as less error information (e.g., quantization errors) is generally available for adaptation as a performance metric (e.g., BER) of DFE circuitry approaches a target performance metric (e.g., a target BER). Some DFE architectures may further limit availability of error information. For example, sources of error information in the system 300 of FIG. 3 may be limited to data signals transmitted by the one or more drivers 318 and feedback signals provided by the feedback circuitry 324 based on DFEₒᵤₜ provided at a respective output 129 of the one or more DFE circuits 326 (e.g., the transmitted signal t(i) and the quantized signal \hat{t}(i) of FIG. 2, respectively.) Additional error information for adaptation of DFE circuitry may be obtained in a controllable manner by oscillating or changing a reference voltage provided for quantizing samples of a data signal. Adaptation of DFE circuitry may be controlled by using an oscillating reference voltage to controllably obtain additional error information in contexts where availability of error information may be limited. For example, an amplitude of an oscillating reference voltage may be increased to induce quantization errors as a performance metric (e.g., a BER) of DFE circuitry approaches a target performance metric.

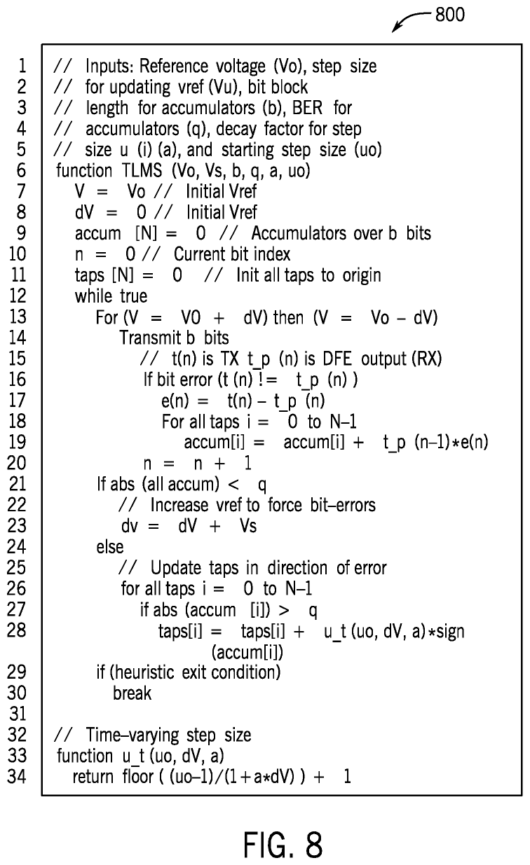

FIG. 8 is example pseudocode 800 for implementing adaptive DFE tuning of DFE circuitry, in accordance with aspects of the present disclosure. In an embodiment, the pseudocode 800 may implemented by a DFE tuner (e.g., the DFE tuners 114 and/or 314 of FIGS. 1 and 3, respectively). In an embodiment, the pseudo code 800 may be implemented in accordance with one or more of equations (1) through (5). In FIG. 8, inputs provided to the pseudocode 800 may include a quantization threshold voltage (e.g., Vₒ), a reference voltage step size (e.g., Vₛ), an error accumulator block size or an error accumulator bit block length (e.g., b), a bit error threshold for the error accumulator block size (e.g., q), a decay rate parameter for an adaptive tap step size (e.g., α), and an initial tap step size (e.g., μₒ). The pseudocode 800 initializes different parameter states between line 7 and line 11. For example, the pseudocode 800 initializes states of a reference voltage parameter (e.g., VREF), an offset or delta voltage parameter (e.g., V_{Δ}), an error accumulator parameter vector (e.g., accum[N]) that records signed bit errors over a number (e.g., b) of transmitted bits, a current bit index parameter (e.g., n), and a tap weight parameter vector (e.g., taps[N]) that includes a tap weight parameter for each tap of a number (e.g., N) of taps that compose the DFE circuitry.

Line 13 of the pseudocode 800 includes a loop that transmits a number (e.g., the error accumulator block size or b) bits or data symbols over a channel at a first reference voltage (e.g., Vₒ+V_{Δ}) of an oscillating reference voltage and at a second reference voltage (e.g., Vₒ−V_{Δ}) of the oscillating reference voltage. For example, the DFE tuner 314 of FIG. 3 may cause a driver of the one or more drivers 318 to transmit a data signal (e.g., DQ) via a respective channel 337. In an embodiment, the loop at line 13 of the pseudocode 800 may transmit the number of bits in accordance with equation (5). At line 19, the pseudocode 800 updates the error accumulator parameter vector with bit errors corresponding to the number of bits that the loop at line 13 transmits. For example, the DFE tuner 314 of FIG. 3 may receive a feedback signal (e.g., LBDQ) via the feedback interconnect 334. In this example, the feedback signal received by the DFE tuner 314 may be sampled on edges of a corresponding feedback timing signal (e.g., LBDQS). In an embodiment, the pseudocode 800 may update the error accumulator parameter vector at line 19 in accordance with equation (4).

Separation between the first reference voltage (e.g., Vₒ+V_{Δ}) and the second reference voltage (e.g., Vₒ−V_{Δ}) with respect to opposing edges of a data eye may render tracking bit error signs impractical or inefficient. For example, as described above with reference to FIG. 7, probabilities of samples of the data signal corresponding to a first logic value (e.g., a binary “1”) being erroneously represented at a quantization output (e.g., the output 129 of the DFE circuitry 126 of FIG. 1) as a second logic value (e.g., a binary “0”) for the first reference voltage (e.g., Vₒ+V_{Δ}) and vice versa for the second reference voltage (e.g., Vₒ−V_{Δ}) are each relatively high. In an embodiment, the pseudocode 800 may update the error accumulator parameter vector with signed bit errors. In an embodiment, the pseudocode 800 may update the error accumulator parameter vector with unsigned bit errors. At line 23, the pseudocode 800 monotonically updates a value of the offset voltage parameter (e.g., V) if the preceding value provides insufficient pressure for adaptation of the DFE circuitry to the channel. At line 28, the pseudocode 800 updates one or more tap weight parameters of the tap weight parameter vector (e.g., taps[N]) using the error accumulator parameter vector (e.g., accum[N]). In an embodiment, the pseudocode 800 may update the one or more tap weight parameters of the tap weight parameter vector (e.g., taps[N]) at line 28 in accordance with equation (2).

The pseudocode 800 may continue to perform adaptive DFE tuning of the DFE circuitry until one or more exit conditions (e.g., a heuristic exit condition) at line 29 are satisfied. In an embodiment, the one or more exit conditions at line 29 may include a defined runtime duration (e.g., an upper-bound of runtime). Adaptive DFE tuning implemented by the pseudocode 800 may be runtime deterministic when the one or more exit conditions include a defined runtime duration. In some instances, adaptive DFE tuning implemented by the pseudocode 800 may terminate prematurely when the one or more exit conditions include a defined runtime duration. For example, the adaptive DFE tuning may terminate when an accuracy of at least one tap weight value of the DFE circuitry is less than optimal.

In an embodiment, the one or more exit conditions at line 29 may include a deviation threshold (e.g., a lower-bound of deviation) for the tap weight parameter vector (e.g., taps[N]). For example, adaptive DFE tuning implemented by the pseudocode 800 may evaluate deviation of at least one tap weight parameter of the tap weight parameter vector over an observation window (e.g., a defined time period and/or a defined number of tap weight updates). In this example, adaptive DFE tuning implemented by the pseudocode 800 may terminate when the deviation of the at least one tap weight parameter does not exceed the deviation threshold over the observation window, such as when there is a net zero change in the at least one tap weight parameter over the observation window. In an embodiment, the adaptive DFE tuning implemented by the pseudocode 800 may evaluate the deviation by comparing a current value of the at least one tap weight parameter with preceding values over the observation window. In an embodiment, a value of the at least one tap weight parameter over the observation window may be averaged to update that tap weight parameter when the deviation does not exceed the deviation threshold.

In an embodiment, deviation or a rate of change in a tap weight parameter over an observation window may be referred to as tap velocity. A tap weight parameter may have zero tap velocity when there is a net zero change or deviation in the tap weight parameter over an observation window; otherwise, the tap weight parameter may have a non-zero tap velocity. DFE tuning operation with zero tap velocity may appear physically as random, Brownian motion at lower values of BER. In FIG. 5, the convergence behavior of line 512 (e.g., DFE tuning implemented with a relatively small tap step size) proximate to region 508 (e.g., the minimal region of the BER performance surface) may represent an example of DFE tuning operation with zero tap velocity.

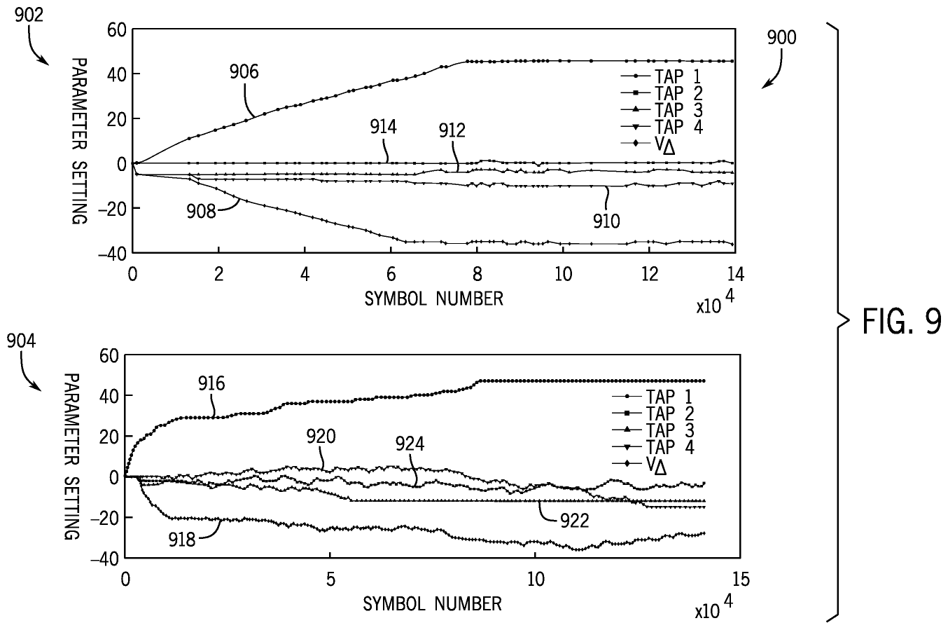

FIG. 9 is a diagram 900 of example convergence plots that show a comparison of convergence behavior between implementations of adaptive DFE tuning in simulation and hardware environments. Each convergence plot of the diagram 900 represents various parameter values as a function of runtime duration. The diagram 900 represents a runtime duration of each adaptive DFE tuning implementation in terms of training pattern symbols or bits rather than time to present runtime performance metrics in a manner that is agnostic to both the physical layer (PHY) technology and the data transfer rate (e.g., memory frequency). The diagram 900 includes convergence plots 902 and 904. Convergence plots 902 and 904 represent convergence behavior of adaptive DFE tuning implemented in simulation and hardware environments, respectively.

The simulation environment implementation represented by convergence plot 902 included a memory model, a DFE model, and a channel model to provide cycle-accurate simulation granularity. In an embodiment, the memory model and/or the DFE model may be a DDR5 compliant model. The DFE model was implemented at a receiver of the memory model in accordance with the DFE architecture implemented by the system 300 of FIG. 3. The channel model was configured to model noise injected into a communication channel by applying constrained-randomization of arbitrary ISI for each transmitted pulse alongside Gaussian noise injection. Convergence plot 902 includes line 906 that corresponds to a delta voltage parameter (e.g., V_{Δ}) of the simulation environment implementation. Convergence plot 902 also includes lines 908, 910, 912, and 914 that correspond to first, second, third, and fourth tap weight parameters of the simulation environment implementation, respectively.

The hardware environment implementation represented by convergence plot 904 included an FPGA (e.g., an INTEL® AGILEX™ 7 M-Series FPGA by INTEL CORPORATION of Santa Clara, California) coupled to a memory module (e.g., a single rank 16 GB 4×8 DDR5 Unbuffered Dual In-Line Memory Module (UDIMM) memory) by a silicon interposer. Convergence plot 904 includes line 916 that corresponds to an offset voltage parameter (e.g., V_{Δ}) of the hardware environment implementation. Convergence plot 904 also includes lines 918, 920, 922, and 924 that correspond to first, second, third, and fourth tap weight parameters of the hardware environment implementation, respectively.

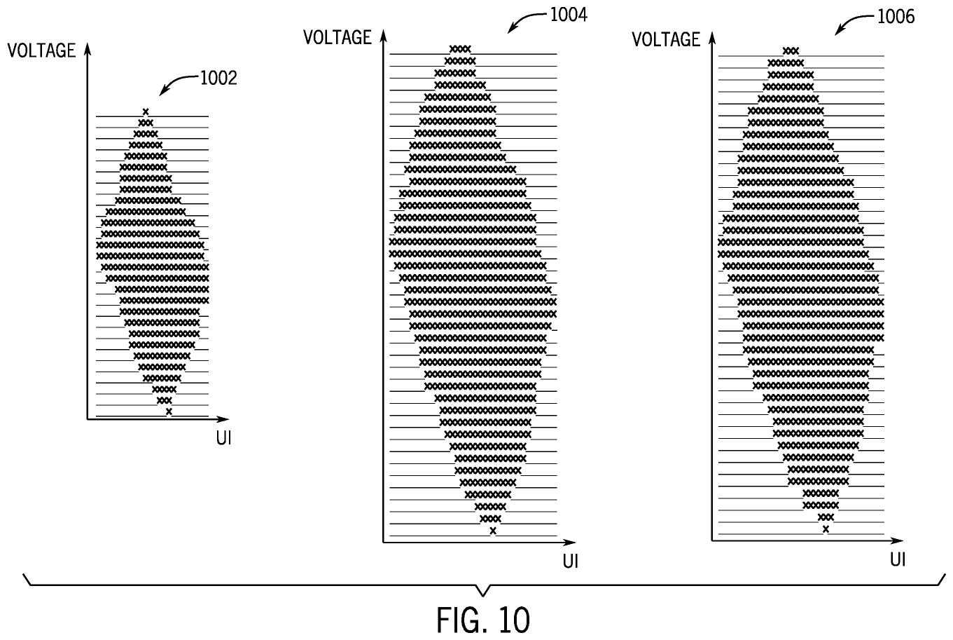

FIG. 10 is a diagram 1000 of example shmoo plots that compare receiver circuit performance with different DFE implementations. Each shmoo plot of the diagram 1000 shows a data eye at an input of DFE circuitry in voltage as a function of unit intervals or time. The diagram 1000 includes shmoo plots 1002, 1004, and 1006. The shmoo plot 1002 generally illustrates receiver circuit performance when the DFE circuitry is disabled or bypassed. The shmoo plots 1004 and 1006 each generally illustrate receiver circuit performance when the DFE circuitry is enabled. A comparison between the shmoo plot 1002 and either the shmoo plot 1004 or the shmoo plot 1006 illustrates that enabling the DFE circuitry may improve receiver circuit performance. For example, the shmoo plots 1004 and 1006 each show a data eye with dimensions that are larger than corresponding dimensions of the data eye shown by the shmoo plot 1002 in terms of both height (e.g., voltage) and width (e.g., unit intervals or time). In FIG. 10, each step of the vertical-axis entitled “Voltage” may be about 5.5 mV and each step of the horizontal axis entitled “UI” may be about 1/64^{th} of a symbol.

Tap weights of the DFE circuitry corresponding to the shmoo plot 1004 were set with zero forcing (ZF) criterion-based DFE tuning from channel pulse response measurements. Tap weights of the DFE circuitry corresponding to the shmoo plot 1006 were set with adaptive DFE tuning, in accordance with aspects of the present disclosure. A comparison between the shmoo plot 1004 and the shmoo plot 1006 illustrates that receiver circuit performance with adaptive DFE tuning may be the same or substantially similar to receiver circuit performance with ZF criterion-based DFE tuning. For example, the height dimension (e.g., about 225.5 millivolts (mV)) of the data eye shown by the shmoo plot 1006 may be the same or substantially similar to the height dimension (e.g., about 225.5 mV) of the data eye shown by the shmoo plot 1004. As another example, the width dimension (e.g., about 0.23 UI) of the data eye shown by the shmoo plot 1006 may be the same or substantially similar to the width dimension (e.g., about 0.23 UI) of the data eye shown by the shmoo plot 1004.

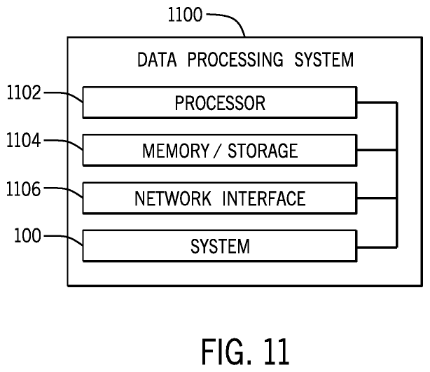

With the foregoing in mind, the system 100 may be a component included in a data processing system, such as a data processing system 1100, shown in FIG. 11. The data processing system 1100 may include a processor 1102, memory and/or storage circuitry 1104, a network interface 1106, and the system 100. The data processing system 1100 may include more or fewer components (e.g., electronic display, user interface structures, application specific integrated circuits (ASICs)). The processor 1102 may include any of the foregoing processors that may manage a data processing request for the data processing system 1100 (e.g., to perform encryption, decryption, machine learning, video processing, voice recognition, image recognition, data compression, database search ranking, bioinformatics, network security pattern identification, spatial navigation, cryptocurrency operations, or the like). In an embodiment, the processor 1102 may include the host processor 310.

The memory and/or storage circuitry 1104 may include random access memory (RAM), read-only memory (ROM), one or more hard drives, flash memory, or the like. In an embodiment, the memory and/or storage circuitry 1104 may include the memory module 320. The memory and/or storage circuitry 1104 may hold data to be processed by the data processing system 1100. In some cases, the memory and/or storage circuitry 1104 may also store configuration programs (e.g., bitstreams, mapping function) for programming the system 100. The network interface 1106 may allow the data processing system 1100 to communicate with other electronic devices. The data processing system 1100 may include several different packages or may be contained within a single package on a single package substrate. For example, components of the data processing system 1100 may be located on several different packages at one location (e.g., a data center) or multiple locations. For instance, components of the data processing system 1100 may be located in separate geographic locations or areas, such as cities, states, or countries. The data processing system 1100 may be part of a data center that processes a variety of different requests. For instance, the data processing system 1100 may receive a data processing request via the network interface 1106 to perform encryption, decryption, machine learning, video processing, voice recognition, image recognition, data compression, database search ranking, bioinformatics, network security pattern identification, spatial navigation, digital signal processing, or other specialized tasks.

While the embodiments set forth in the present disclosure may be susceptible to various modifications and alternative forms, specific embodiments have been shown by way of example in the drawings and have been described in detail herein. However, it should be understood that the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

### Example Embodiments

EXAMPLE EMBODIMENT 1. An integrated circuit including interface circuitry coupled to decision feedback equalization (DFE) circuitry by data interconnect. The integrated circuit also includes a DFE tuner to control adaptation of the DFE circuitry using an oscillating reference voltage provided to the DFE circuitry, where the interface circuitry is coupled between the DFE tuner and the DFE circuitry.

EXAMPLE EMBODIMENT 2. The device of example embodiment 1, where the DFE tuner is to cause the interface circuitry to transmit training data at first and second voltages of the oscillating reference voltage, and where a quantization threshold voltage is between the first and second voltages.

EXAMPLE EMBODIMENT 3. The device of example embodiment 1, where the DFE tuner is to control adaptation of the DFE circuitry by increasing an amplitude of the oscillating reference voltage as a performance metric of the DFE circuitry approaches a target performance metric.

EXAMPLE EMBODIMENT 4. The device of example embodiment 1, where the DFE tuner is to induce quantization errors at the DFE circuitry by increasing an amplitude of the oscillating reference voltage.

EXAMPLE EMBODIMENT 5. The device of example embodiment 1, where the DFE tuner is to control adaptation of the DFE circuitry by updating a tap weight of the DFE circuitry with an adaptive tap step size that varies over time.

EXAMPLE EMBODIMENT 6. The device of example embodiment 5, where the DFE tuner is to control a magnitude of the adaptive tap step size based on an amplitude of the oscillating reference voltage.

EXAMPLE EMBODIMENT 7. The device of example embodiment 5, where the DFE tuner is to control a magnitude of the adaptive tap step size based on a decay rate parameter.

EXAMPLE EMBODIMENT 8. The device of example embodiment 5, where an initial tap step size of the adaptive tap step size controls a convergence rate associated with adaptation of the DFE circuitry.

EXAMPLE EMBODIMENT 9. The device of example embodiment 1, where the DFE tuner is to cease adaptation of the DFE circuitry based on a tap velocity threshold.

EXAMPLE EMBODIMENT 10. The device of example embodiment 1, where the DFE tuner is to trigger a tap update for the DFE circuitry based on a quantization error threshold and an accumulator error signal indicative of multiple quantization errors detected.

EXAMPLE EMBODIMENT 11. The device of example embodiment 1, where the DFE tuner is to filter quantization errors induced by noise based on an error accumulator block size, a quantization error threshold, or a combination thereof.

EXAMPLE EMBODIMENT 12. The device of example embodiment 1, where a memory module comprising the DFE circuitry is compatible with a double data rate (DDR) standard.

EXAMPLE EMBODIMENT 13. The device of example embodiment 1, where the oscillating reference voltage is centered at a quantization threshold voltage of a data signal.

EXAMPLE EMBODIMENT 14. A device that includes decision feedback equalization (DFE) circuitry coupled to interface circuitry by data interconnect, where the DFE circuitry is to equalize a data signal received over the data interconnect. The device also includes control circuitry coupled to a DFE tuner by a control interconnect that is separate from the data interconnect, where the control circuitry is to receive a control signal from the DFE tuner over the control interconnect and to provide an oscillating reference voltage to the DFE circuitry based on the control signal.

EXAMPLE EMBODIMENT 15. The device of example embodiment 14, that also includes feedback circuitry coupled to the interface circuitry by feedback interconnect that is separate from the data interconnect, where the feedback circuitry is to receive a quantized signal from the DFE circuitry based on the data signal and is to provide the quantized signal to the interface circuitry over the feedback interconnect.

EXAMPLE EMBODIMENT 16. The device of example embodiment 15, where the quantized signal causes the DFE tuner to send an updated control signal to the control circuitry over the control interconnect, and the control circuitry is to increase an amplitude of the oscillating reference voltage provided to the DFE circuitry based on the updated control signal.

EXAMPLE EMBODIMENT 17. The device of example embodiment 14, where the interface circuitry is coupled between the DFE circuitry and a memory controller of a host processor.

EXAMPLE EMBODIMENT 18. A system that includes a memory module and a host processor. The memory module includes decision feedback equalization (DFE) circuitry coupled to data interconnect. The host processor includes a DFE tuner and interface circuitry, where the DFE tuner is to control adaptation of the DFE circuitry using an oscillating reference voltage provided to the DFE circuitry, and the interface circuitry is coupled between the DFE tuner and the data interconnect.

EXAMPLE EMBODIMENT 19. The system of example embodiment 18, where the memory module includes a registered clock driver (RCD).

EXAMPLE EMBODIMENT 20. The system of example embodiment 18, where the host processor is to communicate with the memory module over the data interconnect in accordance with a double data rate version 5 (DDR5) memory technology or standard.

What is claimed is:

1. A device comprising:
interface circuitry coupled to decision feedback equalization (DFE) circuitry by data interconnect; and
a DFE tuner to control adaptation of the DFE circuitry using an oscillating reference voltage provided to the DFE circuitry, wherein the interface circuitry is coupled between the DFE tuner and the DFE circuitry.

2. The device of claim 1, wherein the DFE tuner is to cause the interface circuitry to transmit training data at first and second voltages of the oscillating reference voltage, and wherein a quantization threshold voltage is between the first and second voltages.

3. The device of claim 1, wherein the DFE tuner is to control adaptation of the DFE circuitry by increasing an amplitude of the oscillating reference voltage as a performance metric of the DFE circuitry approaches a target performance metric.

4. The device of claim 1, wherein the DFE tuner is to induce quantization errors at the DFE circuitry by increasing an amplitude of the oscillating reference voltage.

5. The device of claim 1, wherein the DFE tuner is to control adaptation of the DFE circuitry by updating a tap weight of the DFE circuitry with an adaptive tap step size that varies over time.

6. The device of claim 5, wherein the DFE tuner is to control a magnitude of the adaptive tap step size based on an amplitude of the oscillating reference voltage.

7. The device of claim 5, wherein the DFE tuner is to control a magnitude of the adaptive tap step size based on a decay rate parameter.

8. The device of claim 5, wherein an initial tap step size of the adaptive tap step size controls a convergence rate associated with adaptation of the DFE circuitry.

9. The device of claim 1, wherein the DFE tuner is to cease adaptation of the DFE circuitry based on a tap velocity threshold.

10. The device of claim 1, wherein the DFE tuner is to trigger a tap update for the DFE circuitry based on a quantization error threshold and an accumulator error signal indicative of multiple quantization errors detected.

11. The device of claim 1, wherein the DFE tuner is to filter quantization errors induced by noise based on an error accumulator block size, a quantization error threshold, or a combination thereof.

12. The device of claim 1, wherein a memory module comprising the DFE circuitry is compatible with a double data rate (DDR) standard.

13. The device of claim 1, wherein the oscillating reference voltage is centered at a quantization threshold voltage of a data signal.

14. A device comprising:
decision feedback equalization (DFE) circuitry coupled to interface circuitry by data interconnect, wherein the DFE circuitry is to equalize a data signal received over the data interconnect; and
control circuitry coupled to a DFE tuner by a control interconnect that is separate from the data interconnect, wherein the control circuitry is to receive a control signal from the DFE tuner over the control interconnect and to provide an oscillating reference voltage to the DFE circuitry based on the control signal.

15. The device of claim 14, comprising feedback circuitry coupled to the interface circuitry by feedback interconnect that is separate from the data interconnect, wherein the feedback circuitry is to receive a quantized signal from the DFE circuitry based on the data signal and is to provide the quantized signal to the interface circuitry over the feedback interconnect.

16. The device of claim 15, wherein the quantized signal causes the DFE tuner to send an updated control signal to the control circuitry over the control interconnect, and the control circuitry is to increase an amplitude of the oscillating reference voltage provided to the DFE circuitry based on the updated control signal.

17. The device of claim 14, wherein the interface circuitry is coupled between the DFE circuitry and a memory controller of a host processor.

18. A system comprising:
a memory module that includes decision feedback equalization (DFE) circuitry coupled to data interconnect; and
a host processor that includes a DFE tuner and interface circuitry, wherein the DFE tuner is to control adaptation of the DFE circuitry using an oscillating reference voltage provided to the DFE circuitry, and the interface circuitry is coupled between the DFE tuner and the data interconnect.

19. The system of claim 18, wherein the memory module includes a registered clock driver (RCD).

20. The system of claim 18, wherein the host processor is to communicate with the memory module over the data interconnect in accordance with a double data rate version 5 (DDR5) memory technology or standard.
